(19) United States
(12) Patent Application Publication
(10) Pub. No.: US 2026/0236527 A1
(43) Pub. Date: Aug. 13, 2026

(54) FINGERPRINT INDEXING USING CONVOLUTIONAL NEURAL NETWORK

(71) Applicant: THALES DIS FRANCE SAS, Meudon (FR)

(72) Inventors: Young AN, Beijing (CN); Huimin DENG, Beijing (CN); Shark YU, Beijing (CN)

(73) Assignee: THALES DIS FRANCE SAS, Meudon (FR)

(21) Appl. No.: 19/470,843

(22) PCT Filed: Mar. 29, 2024
(86) PCT No.: PCT/EP2024/058787

§ 371 Date: Sep. 30, 2025

(30) Foreign Application Priority Data
Mar. 31, 2023 (CN) 202310340032.5

(51) Int. Cl. G06F 16/535; G06V 10/74; G06V 10/82; G06V 40/12

(52) U.S. Cl. CPC G06F 16/535; G06V 10/761; G06V 10/82; G06V 40/1353; G06V 40/1365

(57) ABSTRACT

A method of filtering fingerprint candidates, the method being carried out by an indexing module arranged to access a Convolutional Neuronal Network, CNN configured to output at least one feature of an input image. The method comprises processing an image representative of local information of a searched fingerprint, by the CNN to obtain at least one feature for the searched fingerprint; retrieving a candidate fingerprint in a database; determining whether at least one feature of the retrieved candidate fingerprint matches with the at least one feature of the searched fingerprint; if the at least one feature of the retrieved candidate fingerprint matches with the at least one feature of the searched fingerprint, passing the at least one candidate fingerprint to a matching module for further comparison between the candidate fingerprint and the searched fingerprint. Other aspects are also considered.

### FIELD OF USE

This invention is related to the field of personal identification, and more particularly, to personal identification using fingerprint.

The invention is particularly useful when implemented in an Automated Biometric Identification System, for example to identify a person or to grant access to some resources or services.

### BACKGROUND

Fingerprint, due to its lifelong invariance, uniqueness and convenience, is widely used for personal identification. In addition, with the development of personal computers, fingerprint capture became simple and convenience.

With the wide application of many Automatic Fingerprint Identification Systems (AFIS), the scale of fingerprint database is also growing.

Some or the largest databases may comprise more than 100 millions, an even more than 1 billon, registered individuals.

Fingerprint identification consists in comparing one or more fingerprints of a searched subject with all fingerprints of a large database. Identification accuracy and search efficiency are both critical criteria to be met by a fingerprint identification method of an AFIS system.

One of the most authoritative fingerprint algorithm performance evaluation systems is NIST FPVTE2012, which stands for National Institutes of Standards and Technology—Fingerprint Supplier Technology Evaluation, and which is a large-scale one to many fingerprint identification algorithm evaluation using millions of registered sample sizes. The algorithm evaluation has different test scenarios using one, two, four, eight or ten fingerprints to search in a database.

The most accurate identification algorithm that had been submitted up to the filing date of this invention, obtained a False Negative Identification Rate, FNIR, of 1,9% for the right index finger.

For a two finger search and a ten finger search, the optimal FNIR is 0.27% and 0.09% respectively.

This is why in most of the AFIS systems, two or more fingerprints are used for identification.

However, it is also shown that the matching time of the most accurate submissions is about 1 or 2 ms for a single comparison.

Therefore, applying these solutions to a large database would lead to an unacceptable processing time for time-sensitive applications.

Some methods have been proposed to speed up the matching.

To filter the candidate list of the database, exclusive classification methods divide the whole candidate list in a fixed number of classes.

During the matching step, the searched fingerprint is merely compared with the candidate fingerprints belonging to the same category.

Some existing AFIS use exclusive classification for ten fingerprints to ten fingerprints matching, and exclusive classification can shorten the candidate list to a PR of 12%, with a very low MR that is below 0.1%.

Fingerprint indexing is used to apply a filtering to fingerprint candidates in a large-scale fingerprint identification system comprising a candidate list of fingerprints. It can quickly delete most candidate fingerprints to retain a small part of filtered candidate fingerprints, for a further accurate, but slow, matching step with the searched fingerprint.

An effective fingerprint indexing method should ensure that the fingerprint of the search belongs to the filtered candidate fingerprints, the performance of which can be measured by a Penetration Rate, PR, a missing rate MR and an indexing speed. The PR is the ratio of the number of filtered candidate fingerprints over the number of candidate fingerprints in the whole candidate list. The MR is the ratio of failed filtering situations, which correspond to situations where the candidate fingerprint matching the searched fingerprint, is filtered during the fingerprint indexing step.

An optimal fingerprint indexing method aims to minimize both PR, for accelerating the whole process or reducing the resources involved, and MR, for accuracy, with an extremely fast speed indexing.

Many indexing techniques have been proposed in the past.

They can be grouped into two categories according to the type of features they use to index the fingerprints: global features based and local features based.

Global features define global patterns or ridges, which may use direction field FingerCode, or texture.

Local features that are usually used comprise minutiae and their neighbourhood, such as the MCC, so-called Minutia Cylinder-Code, or minutia and ridge flow curvature. Further methods using minutiae are described in the patents U.S. Pat. No. 6,941,003 B2, U.S. Pat. No. 6,941,807 B1 and U.S. Pat. No. 8,265,861 B2.

However, there is a need for an indexing technique that is both fast and accurate with a very low penetration rate.

The invention aims at improving the situation.

### SUMMARY

A first aspect of the invention concerns a method of filtering a candidate fingerprint, the method being carried out at least by an indexing module, the indexing module being arranged to access a Convolutional Neuronal Network, CNN, configured to receive an image and to output at least one feature of said image, the method comprising the following steps:
receiving a searched fingerprint;
determining an image being representative of local information detected in the searched fingerprint;
processing the determined image by the CNN to obtain at least one feature for the searched fingerprint;
retrieving a candidate fingerprint from a database;
determining whether at least one feature of the retrieved candidate fingerprint matches with the at least one feature of the searched fingerprint;
if the at least one feature of the retrieved candidate fingerprint matches with the at least one feature of the searched fingerprint, passing the at least one candidate fingerprint to a matching module for further comparison between the candidate fingerprint and the searched fingerprint.

The use of a CNN applied to local information of the searched fingerprint allows a fast determination of the at least one feature, and allows a fast comparison with the corresponding features of the candidate fingerprints of the database. In addition, the PR allowed by this method can be very low with a very low MR, which can even be equal to zero. The indexing method can therefore be used in an AFIS to rapidly identify a target person providing a fingerprint.

According to some embodiments, the steps of retrieving, determining a match between features, and passing, may be iterated until the matching module determines a match between a candidate fingerprint passed by the indexing module and the searched fingerprint or until all the candidate fingerprints have been retrieved from the database.

Therefore, the method can be terminated when an accurate match is determined by the matching module. This can be determined by the indexing module upon reception of a signal from the matching module, indicating that an accurate match has been found.

In complement, the method may further comprise identifying a searched subject associated with the searched fingerprint carried out by the matching module, based on the further comparison between the candidate fingerprint and the searched fingerprint.

The indexing method can therefore be advantageously used in an AFIS.

According to some embodiments, the CNN may be a MobileFaceNet network.

This CNN allows a good performance while avoiding to request high computational resources. A MobileFaceNet network can be implemented on a mobile device for example.

According to some embodiments, the at least one feature may be a vector of N features, N being larger than or equal to 2, for example a vector of 128 features.

This allows to improve the accuracy of the indexing method, and therefore, the MR can be lowered, even made equal to 0.

In complement, the step of determining whether at least one feature of the retrieved candidate fingerprint matches with the at least one feature of the searched fingerprint may comprise:
determining a cosine distance between the vector of N features of the searched fingerprint and the vector of N features of the candidate fingerprint;
comparing the determined cosine distance with a threshold.

If the determined cosine distance is below the threshold, then the vector of N features of the retrieved candidate fingerprint matches the vector of N features of the searched fingerprint.

This allows an accurate filtering of the candidate fingerprint, which is fast and with low requirements in terms of computational resources.

According to some embodiments, determining an image representative of the local information detected in the searched fingerprint comprises:
detecting minutiae in the received searched fingerprint;
determining respective positions and orientations of the respective minutiae;
determining the image based on the determined respective positions and orientations of the respective minutiae.

Therefore, the at least one feature obtained by the CNN represents the minutiae of the searched fingerprint, which allows to reach low PR and MR by the indexing method.

In complement, the determined image may be a grayscale image, in which minutiae may be allocated to pixels based on their respective positions, and in which each pixel allocated to a given minutia may have a grayscale determined based on the orientation of the given minutiae.

This allows to input an image in the CNN that encodes both the location and the direction of each of the minutiae of the searched fingerprint.

A second aspect of the invention concerns a computer program comprising instructions arranged for implementing the method according to the first aspect of the invention, when said instructions are executed by a processor.

A third aspect of the invention concerns an indexing module storing or configured to access a Convolutional Neuronal Network, CNN, the CNN being configured to receive an image and to output at least one feature of said image, the indexing module further comprising:
a first interface arranged for receiving a searched fingerprint;
a processor configured to:
   determine an image being representative of the local information detected in the searched fingerprint;
   process the determined image by the CNN to obtain at least one feature for the searched fingerprint;
   retrieve a candidate fingerprint in a candidate list of a database, via a second interface of the indexing module;
   determine whether at least one feature of the retrieved candidate fingerprint matches with the at least one feature of the searched fingerprint;
   if the at least one feature of the retrieved candidate fingerprint matches with the at least one feature of the searched fingerprint, pass the at least one candidate fingerprint to a matching module for further comparison between the candidate fingerprint and the searched fingerprint, via a second interface of the indexing module.

A fourth aspect of the invention concerns a matching module configured to perform comparisons between the candidate fingerprint passed by the indexing module according to the third aspect of the invention and the searched fingerprint.

A fifth aspect of the invention concerns a system comprising an indexing module according to the third aspect and a matching module according to the fourth aspect of the invention.

Unless otherwise defined, all terms (including technical and scientific terms) used herein are to be interpreted as is customary in the art. It will be further understood that terms in common usage should also be interpreted as is customary in the relevant art and not in an idealised or overly formal sense unless expressly so defined herein.

In this text, the term “comprises” and its derivations (such as “comprising”, etc.) should not be understood in an excluding sense, that is, these terms should not be interpreted as excluding the possibility that what is described and defined may include further elements, steps, etc.

### BRIEF DESCRIPTION OF THE DRAWINGS

FIG. 1 shows an automatic fingerprint identification system according to some embodiments of the invention;

FIG. 2 illustrates the steps of a method of fingerprint indexing according to some embodiments of the invention;

FIG. 3 shows the structure of an indexing module of an automatic fingerprint identification system according to some embodiments of the invention.

### DETAILED DESCRIPTION

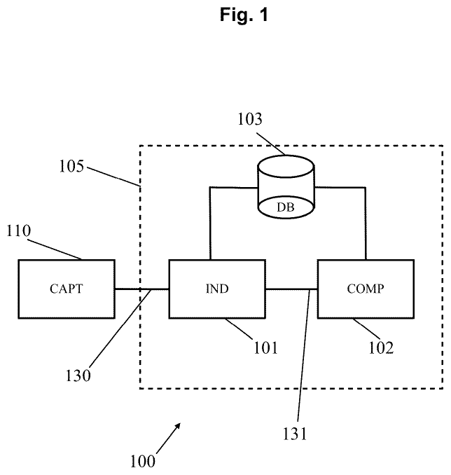

FIG. 1 shows an automatic fingerprint identification system, or AFIS, 100 according to some embodiments of the invention.

The AFIS 100 may be used to identify a searched subject or person, for example to decide whether or not access to a resource or a service can be granted to the subject. No restriction is attached to application using the identification obtained by the AFIS 100 according to the invention.

The AFIS 100 comprises a capture device 110 arranged for acquiring, or capturing, a fingerprint to be searched in a database 103 described hereafter. The fingerprint captured by the capture device 110 is called searched fingerprint in what follows.

No restriction is attached to the searched fingerprint acquired by the capturing device 110, which can be a black and white fingerprint image. No restriction is attached to the resolution, format, colours of the image corresponding to the searched fingerprint according to the invention.

The searched fingerprint is passed by the capturing device 110 via a first communication link 130 to a device 105 according to the invention.

No restriction is attached to the first communication link 130, which can for example be a wireless link, or a wired link. For example, wired protocols may include RS-232, RS-422, RS-485, 12C, SPI, IEEE 802.3 and TCP/IP. Wireless protocols may include IEEE 802.11a/b/g/n, Bluetooth, Bluetooth Low Energy (BLE), FeliCa, Zigbee, GSM, LTE, 3G, 4G, 5G, RFID and NFC.

Alternatively, the device 105 and the capture device 110 are located in different places, and are arranged to communicate via an extended network, such as an IP network for example, not shown on FIG. 1.

The device 105 according to the invention is arranged to identify a subject based on the searched fingerprint obtained from the capture device 110. To this end, the device 105 comprises an indexing module 101 according to the invention and a matching module 102, according to the invention, communicating via a second communication link 131.

No restriction is attached to the second communication link 131, which can for example be a wireless link, or a wired link. For example, wired protocols may include RS-232, RS-422, RS-485, 12C, SPI, IEEE 802.3 and TCP/IP. Wireless protocols may include IEEE 802.11a/b/g/n, Bluetooth, Bluetooth Low Energy (BLE), FeliCa, Zigbee, GSM, LTE, 3G, 4G, 5G, RFID and NFC.

No restriction is attached to the device 105, which can be any device comprising processing capabilities and a non-transitory memory. The device 105 may for example be incorporated into a server, desktop computer, smart tablet, smart phone, mobile internet device, personal digital assistant, wearable device, image capture device or any combination thereof. The device 105 comprises fixed-functionality hardware logic, configurable logic, logic instructions, etc., or any combination thereof.

In the embodiment shown on FIG. 1, the indexing module 101 and the matching module 102 are part of the same device 105. However, the indexing module 102 and the matching module 101 may be implemented or incorporated in separate devices, communicating via a second communication link 131. In that case, the device 105 is separate in two sub-devices communicating via the second communication link 131. The indexing module 102 and the matching module 101 therefore form a system according to the invention, that can be implemented in a single device or in separate devices.

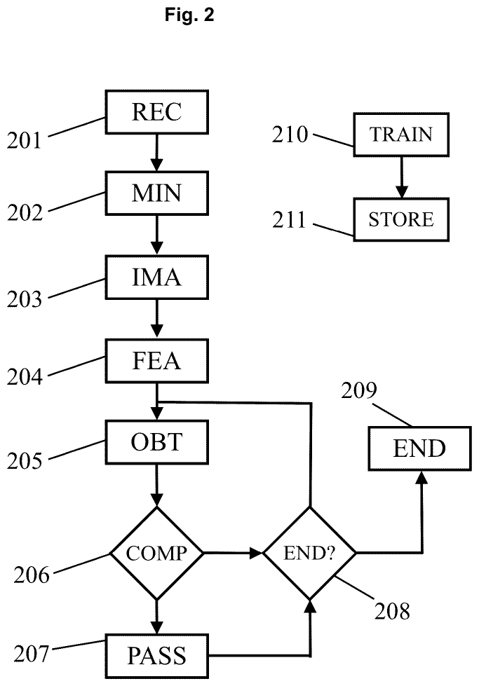

The device 105 may further comprise a database 103 storing candidate fingerprints in association with identity information, such as a number, a name, a surname, or any other information representative of the identity of a person. No restriction is attached to the number of candidate fingerprints of the database, which can be of several thousands of candidate fingerprint, of several millions of candidate fingerprints, or even more than one billion of candidate fingerprints. Also, according to the invention, each candidate fingerprint of the database 103 is associated with at least one feature, and preferably a vector of features, as it will be better understood from the description of FIG. 2.

Alternatively, the database 103 may be external to the device 105 and the device 105 comprises an interface for accessing the external database, that can be stored remotely, such as on a remote server for example. In particular, the interface allows retrieving candidate fingerprints and corresponding features as it will be better understood from the description of FIG. 2 hereafter.

The database 103 can be accessed by the indexing module 101, and optionally by the matching module 102.

The matching module 102 is configured to check a match, called accurate match, between a searched fingerprint and a candidate fingerprint received from the indexing module 101 or retrieved from the database 103. Performing an accurate matching check between fingerprints is well known and can make use of variable techniques. For example, the accurate matching check can be a minutiae based accurate matching for example. Alternatively, the accurate matching may be an image texture-based matching.

According to the invention the indexing module 101 is configured to receive a searched fingerprint, for example in the form of an image, to determine an image based on local information detected in the searched fingerprint, and to submit the determined image to a Convolutional Neuronal Network to obtain at least one feature, and preferably a vector of features, of the searched fingerprint. The at least one feature is then used as index to be compared to corresponding features of candidate fingerprints of the database 103, so as to efficiently filter the candidate fingerprints, as it will be better understood from the description of FIG. 2 hereafter.

CNNs are artificial neural networks that comprise filters or kernels organized in different layers, comprising an input layer, one or several hidden layers, and an output layer. Middle layers are called hidden because they are masked by an activation function, such as ReLU, and a final convolution.

The CNN can be obtained by machine learning using a set of training data. The learning process may be by supervised learning or unsupervised learning for example. The training data can be derived from the candidate fingerprints stored in the database 103. In particular, local information such as minutiae can be obtained for some, or all, of the candidate fingerprints of the database 103, and an image can be determined based on the local information for each candidate fingerprint. In parallel, in case of supervised learning, at least one target feature, or a target vector of feature can be associated with each candidate fingerprint, so as to be used as target.

No restriction is attached to the number of layers and to the type of layers of the CNN. The CNN may be a deep convolutional neuronal network, such as a ResNet network, a Vision Transformer, ViT network, which are heavyweight and performance oriented. However, according to the invention, the CNN is preferably a lightweight deep convolutional neuronal network such as
Shufflenet, described in the article “ShuffleNet: An Extremely Efficient Convolutional Neural Network for Mobile Devices”, by X. Zhang and al, June 2018, IEEE/CVF Conference on Computer Vision and Pattern Recognition (CVPR)
MobileFaceNet, described in the article “MobileFaceNets: Efficient CNNs for Accurate Real-time Face Verification on Mobile Devices”, Sheng Chen and al, April 2018, IEEE.

Shufflenet and MobileFaceNet are examples of neural networks that can be implemented in a mobile device, because they do not require heavy computational capabilities. These two neural networks can be trained to represent local information, such an image of minutiae, of at least some of the candidate fingerprints of the database 103, in the form of at least one feature and preferably in the form of a vector of features.

In Table 1 hereafter, the layers of a MobileFaceNet neural network that can be trained to represent the local information of the candidate fingerprints.

TABLE 1

| Input | Operator | t | c | n | s |
|---|---|---|---|---|---|
| 112² * 3 | conv3*3 | — | 64 | 1 | 2 |
| 56² *64 | Depthwise conv3*3 | — | 64 | 1 | 1 |
| 56² *64 | bottleneck | 2 | 64 | 5 | 2 |
| 56² *64 | bottleneck | 4 | 128 | 1 | 2 |
| 14² *128 | bottleneck | 2 | 128 | 6 | 1 |
| 14² *128 | bottleneck | 4 | 128 | 1 | 2 |
| 7² *128 | bottleneck | 2 | 128 | 2 | 1 |
| 7² *128 | conv1*1 | — | 512 | 1 | 1 |
| 7² *512 | Linear GDCConv7*7 | — | 512 | 1 | 1 |
| 1² *128 | Linear conv1*1 | — | 128 | 1 | 1 |

In Table 1, the column “Input” specifies the size of the data input in each layer and “Operator” specifies the type of layer, or the function performed by each layer. “n” refers to the number of times the operator is applied, “c” refers to the number of output channels, “s” refers to the stride and “t” is an expansion factor applied to the input size. GDConv7*7 denotes the global depthwise convolution of 7*7 kernels.

The at least one feature output by the CNN may therefore be a vector of N features, N being an integer greater than or equal to 2.

In the example of Table 1, the vector of features is a vector of 128 components.

FIG. 2 shows the steps of a method of fingerprint indexing, that is to say to filter fingerprint candidates of the database to reduce the number of candidate fingerprints that are compared with the searched fingerprint by the matching module 102.

The method may be implemented at least by the indexing module 101 previously described.

At step 201, the indexing module 101 receives a searched fingerprint, for example in the form of a fingerprint image, as previously described. The searched fingerprint can be received from the capturing module 110 or from an external database other than the database 103. The searched fingerprint can be received via the first communication link 130 previously described.

At step 202, the indexing module 101 determine local information from the received searched fingerprint. In what follows, the example of local information being minutiae is considered for illustrative purpose. However, other local information may be detected in the searched fingerprint according to the invention. Other examples of local information may be minutiae and their neighbourhood, such as the MCC, so-called Minutia Cylinder-Code, or minutiae and ridge flow curvature.

The minutiae may be detected by identifying position information of the minutiae in the searched fingerprint image. No restriction is attached to the coordinates corresponding to the position information. The position information encompasses any information that allows to determine the position of a minutia in the searched fingerprint.

Detection of a minutia may further involve identifying direction information associated with the minutia. Direction information may be an angular value, being for example a direction value D being an integer varying between 0 and 359°. No restriction is however attached to the direction information, which is any information that allows to describe the direction of the minutia in a fingerprint image.

Identifying direction information and position information of minutiae in a fingerprint image is well known for the person skilled in the art and is not further described in the present description.

At step 203, the indexing module 101 may determine an image being representative of the local information detected at step 202. In particular, the determined image may be obtained based on the position information and the direction information of the minutiae detected in the searched fingerprint.

The image determined at step 203 may therefore represent the minutiae of the searched fingerprint only, while cancelling other information that are comprised in the searched fingerprint.

For example, the image determined at step 203 may comprise pixels, where each pixel that is located at the position of a minutia has a pixel value that depends on the direction information of the minutia. For example, if the range of the pixel value Z, coded on one byte, is [0;255], and the range of D is [0;359] as described above, the pixel value Z of a pixel located at the same position as a minutia, may be determined by the following formula: Z=(D/360)*255.

The pixel value may represent grayscale values, and the determined image may be a grayscale image.

The other pixels that are not located at the same positions as minutiae of may have a default value, such as a black value.

The determined image may have a predetermined size that depends on the input accepted by the CNN. Alternatively, the determined image is adjusted to fit to a size that is accepted by the CNN as input.

Referring for example to the CNN of Table 1, the determined image has a size, or is adjusted to a size, of 112*112 pixels, each pixel being coded on one byte.

In the above description, the indexing module 101 is arranged for implementing steps 201 to 203. However, alternatively, the indexing module 101 may directly receive the image representative of the local information of the searched fingerprint from another module of the device 105, or from a module that is external to the device 105, that is configured to perform steps 201 to 203.

At step 204, the determined image is input to the above described CNN to determine at least one feature describing the local information of the searched fingerprint. As explained above, the at least one feature may be a vector of features, such as a vector of N components. The obtained at least one feature is indexed to the searched fingerprint. In what follows, the example of a vector of features is used for illustrative purposes.

At step 205, a candidate fingerprint is retrieved from the database 103. Preferably, the candidate fingerprint is retrieved with a vector of features associated to the candidate fingerprint.

The vector of features associated to the candidate fingerprint has the same size N as the vector of features determined at step 204, so that they can be compared.

Alternatively, the vector of features of the candidate fingerprint is determined at step 205 upon reception of the candidate fingerprint. However, a faster indexing can be obtained by storing the candidate fingerprints and their vectors of features together in association in the database 103.

At step 206, the vector of features of the searched fingerprint is compared with the vector of features of the candidate fingerprint retrieved from the database 103.

No restriction is attached to the comparison of step 206, which is any calculation applied to both vectors of features, in particular to determine a distance or a similarity between both vectors of features.

For example, the comparison step 206 of may comprise determining a cosine distance between the vector of N features of the searched fingerprint and the vector of N features of the candidate fingerprint and comparing the determined cosine distance with a threshold. The threshold may be a predetermined threshold for example.

The cosine distance can be obtained based on a cosine similarity that can be determined by applying the following formula:

$$Cosinesimilarity = \frac{{\sum }_{i = 1}^{n} {x}_{i} {y}_{i}}{\sqrt{{\sum }_{i = 1}^{n} {x}_{i}^{2}} \sqrt{{\sum }_{i = 1}^{n} {y}_{i}^{2}}}$$

The cosine distance can be obtained as follows:

$$Cosine distance = 1 - Cosine similarity .$$

Based on the result of the comparison, the indexing module determines at step 206 whether the vector of features of the searched fingerprint matches the vector of features of the candidate fingerprint.

If so, that is to say if the vector of features of the searched fingerprint matches the vector of features of the candidate fingerprint (for example because the cosine distance is below the threshold), the method goes on with step 206. Else, that is to say if the vector of features of the searched fingerprint does not match the vector of features of the candidate fingerprint, the method goes directly to step 208, described hereafter, which involves that the candidate fingerprint is discarded and is not passed to the matching module 102.

At step 206, the candidate fingerprint is passed to the matching module 102 so as to be compared with the searched fingerprint, this comparison being an accurate matching as previously explained. The accurate matching may be minutiae based, as previously explained. After step 206, the method goes on with step 208.

Using an accurate match based on minutiae is consistent with the indexing method according to the invention, which is based on local information and in particular on minutiae. The accuracy associated with the matching is therefore improved.

At step 208, the indexing module 101 determines whether the method should be terminated. No restriction is attached to the criterion or criteria used to determine whether the method should be terminated or not. The indexing module 101 may check whether all the candidate fingerprints from the database have been retrieved at step 205. As a complement, the indexing module 101 may check whether an accurate match has been found by the matching module 102 or not. It is to be noted that, upon reception of the passed candidate fingerprint, the matching module 102 compares it with the searched fingerprint to detect an accurate match or not. If not, the candidate fingerprint can be discarded. In case of accurate match, a signal can be sent to the indexing module 101 to indicate that an accurate match has been found. Also, in case of accurate match, the matching module 102 is configured to determine identity information of the searched fingerprint based on identity information associated with the matching candidate fingerprint in the database 103.

If at least one candidate fingerprint of the database has not been retrieved yet at a previous step 205, and if the accurate match has not been found yet by the matching module 102, the method goes back to step 205, and a new candidate fingerprint is retrieved from the database 103.

If all the candidate fingerprints of the database 103 have already been retrieved at previous steps 205, or if the matching module 102 has found an accurate match between the searched fingerprint and one of the candidate fingerprints, the method can be terminated at step 209. Upon reception of a new searched fingerprint, the method can be repeated from step 201.

FIG. 2 also shows preliminary steps 210 and 211, which are performed by entities other than the indexing module 101.

Step 211 corresponds to the building of the CNN, which can be obtained by machine learning by using the candidate fingerprints of the database 103 as training data. At step 212, the CNN can be stored in the device 105 or an access to the CNN can be provided/granted to the device 105.

The method according to the invention enables to perform indexing of the searched fingerprint, which is fast and accurate. Indeed, in practice, feature extraction time using a CPU (Central Processing Unit) of 2.3 GHZ is 24 ms and a GPU (Graphical Processing Unit) such as RTX, is 6 ms for one determined image, when implementing the method according to the invention. The indexing speed (the speed associated with step 206) of the method according to the invention, is 15 millions of candidate fingerprints per second using single thread. For the database NIST14, with a reference database 103 of 1,06 millions of candidate fingerprints, the method according to the invention achieves a PR of 3,03%, with zero missing rate.

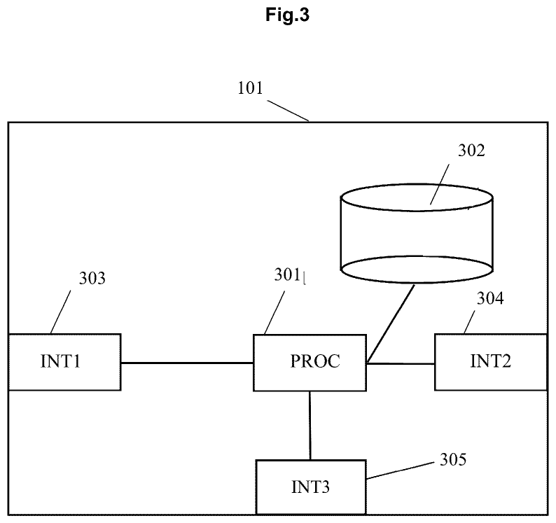

FIG. 3 shows a detailed structure of an indexing module 101 according to some embodiments of the invention.

The indexing module 101 comprises a processor 301 and a memory 302.

The processor 301 may comprise one or multiple microprocessors, a Central Processing Unit (CPU), on a single Integrated Circuit (IC) or several IC chips.

No restriction is attached to the memory 302, which may be any non-transient, tangible form of memory. For example, it can comprise ROM, EEPROM and/or flash memory. The processor 301 may be programmable and may be configured to execute instructions that are stored in its internal memory or to execute instructions that are stored in the memory 302.

The memory 302 can indeed store instructions for implementing the steps 201 to 209 of the method according to the invention described on FIG. 2. According to some embodiments, the indexing module may store the CNN previously described. The CNN can be stored in the memory 302 at step 311 as previously described.

Alternatively, the processor 301 may comprise fixed-functionality hardware logic or configurable logic, configured to implement the steps 201 to 209 of the method according to the invention described on FIG. 2.

The indexing module 101 further comprises a first interface 303 configured to receive the searched fingerprint at step 201 as previously described. Alternatively, the first interface 303 is configured to receive the image determined at step 203, when steps 201 to 203 are carried out by an entity other than the indexing module 101.

More generally, the first interface 303 is configured to receive data via the first communication link 130 previously described.

The indexing module 101 further comprises a second interface 304 configured to forward a candidate fingerprint to the matching module 102 at step 207 as previously explained. Alternatively, an identification information identifying the candidate fingerprint is transmitted to the matching module 102 at step 207, and the matching module 102 is arranged to retrieve the candidate fingerprint corresponding the identification information in the database 103. The indexing module 101 may also transmit the searched fingerprint to the matching module 102 via the second interface 304.

More generally, the second interface 304 is configured to transmit data on the second communication link 131 as previously described.

The indexing module 101 further comprises a third interface 305 configured to access the database 103 as previously described. No restriction is attached to the communication link between the third interface 305 and the database 103, which may use any wired or wireless communication protocol. For example, wired protocols may include RS-232, RS-422, RS-485, 12C, SPI, IEEE 802.3 and TCP/IP. Wireless protocols may include IEEE 802.11a/b/g/n, Bluetooth, Bluetooth Low Energy (BLE), FeliCa, Zigbee, GSM, LTE, 3G, 4G, 5G, RFID and NFC. The interfaces 203 and 204 may comprise hardware (an Ethernet port, a wireless radio), software (drivers, firmware application) or a combination thereof to enable communications with the database 103.

The example embodiments are described in sufficient detail to enable those of ordinary skill in the art to embody and implement the systems and processes herein described. It is important to understand that embodiments can be provided in many alternate forms and should not be construed as limited to the examples set forth herein.

What is claimed, is:

1. A method of filtering a fingerprint candidate, the method being carried out at least by an indexing module arranged to access a Convolutional Neuronal Network (CNN) that is configured to receive an image and to output at least one feature of said image, the method comprising the following steps:
receiving a searched fingerprint;
determining an image being representative of local information detected in the searched fingerprint;
processing the determined image by the CNN to obtain at least one feature for the searched fingerprint;
retrieving a candidate fingerprint in a database;
determining whether at least one feature of the retrieved candidate fingerprint matches with the at least one feature of the searched fingerprint;
if the at least one feature of the retrieved candidate fingerprint matches with the at least one feature of the searched fingerprint, passing the at least one candidate fingerprint to a matching module for further comparison between the candidate fingerprint and the searched fingerprint.

2. The method according to claim 1, wherein the steps of retrieving, determining a match between features, and passing, are iterated until the matching module determines a match between a candidate fingerprint passed by the indexing module and the searched fingerprint or until all the candidate fingerprints have been retrieved from the database.

3. The method according to claim 2, further comprising identifying a searched subject associated with the searched fingerprint carried out by the matching module, based on the further comparison between the candidate fingerprint and the searched fingerprint.

4. The method according to claim 1, wherein the CNN is a MobileFaceNet network.

5. The method according to claim 1, wherein the at least one feature is a vector of N features, N being larger than or equal to 2.

6. The method according to claim 5, wherein the step of determining whether at least one feature of the retrieved candidate fingerprint matches with the at least one feature of the searched fingerprint comprises:
determining a cosine distance between the vector of N features of the searched fingerprint and the vector of N features of the candidate fingerprint;
comparing the determined cosine distance with a threshold;
wherein if the determined cosine distance is below the threshold, then the vector of N features of the retrieved candidate fingerprint matches the vector of N features of the searched fingerprint.

7. The method according to claim 1, wherein determining an image representative of the local information detected in the searched fingerprint comprises:
detecting minutiae in the received searched fingerprint;
determining respective positions and orientations of the respective minutiae;
determining the image based on the determined respective positions and orientations of the respective minutiae.

8. The method according to claim 7, wherein the determined image is a grayscale image, wherein the grayscale image, in which minutiae are allocated to pixels based on their respective positions, and in which each pixel allocated to a given minutiae has a grayscale determined based on the orientation of the given minutiae.

9. (canceled)

10. An indexing module arranged to access or storing a Convolutional Neuronal Network (CNN), the CNN being configured to receive an image and to output at least one feature of said image, the indexing module further comprising:
a first interface arranged for receiving a searched fingerprint;
a processor configured to
determine an image being representative of the local information detected in the searched fingerprint;
process the determined image by the CNN to obtain at least one feature for the searched fingerprint;
retrieve a candidate fingerprint in a candidate list of a database, via a second interface of the indexing module;
determine whether at least one feature of the retrieved candidate fingerprint matches with the at least one feature of the searched fingerprint;
if the at least one feature of the retrieved candidate fingerprint matches with the at least one feature of the searched fingerprint, passing the at least one candidate fingerprint to a matching module for further comparison between the candidate fingerprint and the searched fingerprint, via a second interface of the indexing module.

11. A matching module configured to perform comparisons between the candidate fingerprint passed by the indexing module according to claim 10, and the searched fingerprint.

12. (canceled)
